(19) United States
(12) Patent Application Publication
(10) Pub. No.: US 2016/0081444 A1
(43) Pub. Date: Mar. 24, 2016

(54) VERTICAL SUPPORT BASE AND ANCHORING SYSTEM

(71) Applicant: Donald T. Munsch, Santa Rosa, CA (US)

(72) Inventor: Donald T. Munsch, Santa Rosa, CA (US)

(21) Appl. No.: 14/491,611

(22) Filed: Sep. 19, 2014

(51) Int. Cl. A45B 25/00; F16M 11/22; F16M 11/08

(52) U.S. Cl. CPC A45B 25/00; F16M 11/08; F16M 11/22; A45B 2025/003

(57) ABSTRACT

A vertical support base and anchoring system that includes a ballast container having an open top, a closed bottom, and an interior side or sides uniformly tapering slightly outward from the closed bottom to the open top. A base plate with a flat bottom rests on the closed bottom and includes a threaded female socket disposed on an upper side, and vertically disposed parallel mounting brackets having holes for insertion of retaining bolts, and corner elements configured in relation to the mounting brackets to create a socket for securing the bottom end of a post. The base plate generally conforms in shape to the closed bottom and has an outer perimeter edge slightly spaced apart from the container interior sides.

### CROSS REFERENCES TO RELATED APPLICATIONS

Not applicable. The present application is an original and first-filed United States Utility Patent Application.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to bases and anchors for vertical supports, and more particularly to pole and support standard base and anchoring systems, and still more particularly to a vertical support base and anchoring system for umbrellas and vertical frame members of temporary canopies, tents, and shelters.

2. Background Discussion

To call someone or something “a day at the beach” is to indicate that he, she, or it is delightful, relaxing, fun and easy. Ironically, it's possible to have something very much different than a day at the beach while actually at the beach, for instance when watching one's umbrella or tent blow down the beach, which is anything but delightful, relaxing, fun, and easy. Yet, when it comes to umbrella or pole anchoring systems used to support a beach umbrella or canopy, most allow just that to happen when winds are present, and coastal zones are generally windy.

What's more, coastal zones are not merely generally windy, they are frequently, if not generally, barren (i.e., utterly bereft of trees), at least in those areas where beachgoers congregate to play in the surf and on the sand. Accordingly, on sandy beaches, there is little shade to be found, and those who know enough to limit sun exposure therefore carry their own screening or shading systems, generally only simple screening in the form of sunscreen through actual shading by the use of beach umbrellas, small and large scale pop-up canopies, shelters, and tents. Thus, for a day at the beach, a beachgoer may just have to suffer a “day at the beach . . . not.”

This is because with larger shading apparatus, a problem in the first instance is that they require installation on unstable sand. The second problem, deriving from the first, is that once installed, they are often unstable and prone to falling over or tilting from differences in sand compaction. They are also prone to being moved laterally by even slight contact from people and dogs. The third problem is that even if successfully installed level and laterally stable, the upright supports for shade covers (or the stakes securing the supports) easily dislodge from sand when under wind loads and can turn over and blow down the beach.

These problems, of course, are not limited to the beach environment, though they are slightly less acute. However, the kind of shade cover suitable for use at the beach may not be the preferred kind of cover desired in a more inland environment. Further, the lightweight standards or upright supports on umbrellas and portable canopies and tents may not be the kind of support employed by the user. On structures such as portable garages and heavy duty pop-up canopies and shelters with substantial frame members, the upright supports may be significantly larger and heavier than those found on portable recreational use structures. Thus, it would be desirable to have a vertical support and anchoring system adapted for use with both lightweight standards and heavy duty upright support frame members.

Because the above-described problems have long been appreciated by beachgoers and vendors who routinely use temporary shelters at fairs and local farmer's markets, numerous solutions have been proposed. Representative solutions are set out in the following U.S. patents:

U.S. Pat. No. 6,446,649, to Bigford, for describes an umbrella anchoring system using a plurality of containers connected to a ring disposed on the shaft of an umbrella. The containers contain a material or object that provides weight to the containers, preferably equal to the combined weight of the umbrella and the shaft.

U.S. Pat. No. 8,439,058, to Doell, teaches an anchoring system for a portable shelter that includes a plurality of anchor assemblies each having a support surface for supporting one of the legs of the portable shelter above the ground when the leg rests on the support surface. The anchor assemblies are positioned under the legs of the portable shelter, and each anchor assembly includes a container, a retainer and an attachment. The container forms a hollow interior space for holding weighting material and has a removable lid forming the support surface. The retainer blocks the leg from sliding off of the support surface. The attachment includes an anchor plate located within the hollow interior space and below the weighting material and a cable extending from the anchor plate and out of the container for attachment to the tensioning line.

U.S. Pat. No. 5,271,196, to Fanti, discloses a stabilizer-retention device for beach umbrellas the requires an attachment or modification of the umbrella supporting standard to increase the lateral stability and static retention of the umbrella, in a preferred embodiment shown as a plate attached to the lower end of the supporting rod or an open-topped container embedded in the sand for receiving the beach umbrella rod or standard.

U.S. Pat. No. 6,895,982, to Shaw, teaches a 5½ gallon carrying bucket that can be converted to a support stand for an umbrella. The bucket can be used to carry supplies to a beach where an umbrella stand can be attached to the bucket so that the bucket functions as an above ground ballast anchor to support the umbrella in an upright position.

The foregoing patents reflect the current state of the art of which the present inventors are aware. Reference to, and discussion of, these patents is intended to aid in discharging Applicants' acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

Specifically, none of the foregoing patents teach or disclose a pole support and anchoring system adaptable for use with both lightweight supports and heavy frame members, and that uses a simple base plate for securing the end of an upright member, which base plate can then be placed in a ballast container to effectively secure the upright member to ground. Further, no known prior art documents teach an upright support that includes a vertical support tube having a clamping assembly that secures the upright member to the vertical support tube (and thus to the base plate and ballast container), but also allows free rotation of cylindrical upright supports within the vertical support tube.

### BRIEF SUMMARY OF THE INVENTION

The present invention is a support base and ballast apparatus for anchoring upright support rods, poles, and standards, such as poles and frame members for umbrellas, shelters, tents, and canopies.

It is a principal object of the present invention to provide a new and improved upright support for umbrella, tent, canopy, and other kinds of shelter and shade apparatus that employs a simple ballast container both to anchor and secure the supports at the bottom ends.

It is another object of the present invention to provide a new and improved yet inexpensive upright support base and anchoring system.

A further object or feature of the present invention is a new and improved upright support and anchoring system that uses simple weight bearing material, such as sand or rock, for an anchoring ballast.

An even further object of the present invention is to provide a novel upright support and anchoring system that uses a common 5 gallon bucket as a ballast container.

A still further object and feature of the present invention is that it employs a base plate that can secure an upright support in one of several ways.

Yet another feature and advantage of the present invention is that it allows removal of the umbrella, canopy, tent, or other shelter upright support rod or shaft, without having to dismantle the ballast and base apparatus.

Those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is an upper perspective view showing a first preferred embodiment of the vertical support and anchoring system of the present invention, shown supporting a golf or beach umbrella;

FIG. 2 is an upper perspective view showing the installable base plate and bracket employed in the anchoring system of the present invention;

FIG. 3 is an upper perspective view showing a first preferred embodiment of the inventive support and anchoring system, shown with the umbrella support configured for placement in a ballast container;

FIG. 4 is an upper perspective view showing the same embodiment disposed in ballast container (viz., a bucket);

FIG. 5A is a partial perspective view of the upper end of the of the vertical support member showing the threaded neck and slotted locking collar employed to secure an umbrella;

FIG. 5B is a partial perspective view of the upper end of the vertical support member showing an umbrella handle inserted into the vertical support and the locking collar installed so as to secure the umbrella within the vertical support;

FIG. 6A is an exploded view of the upper end of the vertical support, slotted locking collar, and locking ring;

FIG. 6B is the same view showing the structural elements assembled with an umbrella handled inserted into the vertical support and the locking collar and locking ring combining to secure the umbrella while also allowing the umbrella to rotate about the umbrella shaft;

FIG. 7A is an exploded view of alternative slotted locking collar and locking ring configurations, showing a threaded exterior side on the locking collar and a slotted locking ring having female threads;

FIG. 7A is an assembled view thereof;

FIG. 8A is an upper perspective view showing use of the base plate to secure a 4×4 upright post;

FIG. 8B is an upper perspective view showing the post and base plate placed into a ballast container;

FIG. 9 is an upper perspective view showing the base plate with female threaded receptacle for accepting vertical support or upright support having a male threaded end; and

FIG. 10 is a cross-sectional side view in elevation showing the same elements assembled.

### DETAILED DESCRIPTION OF THE INVENTION

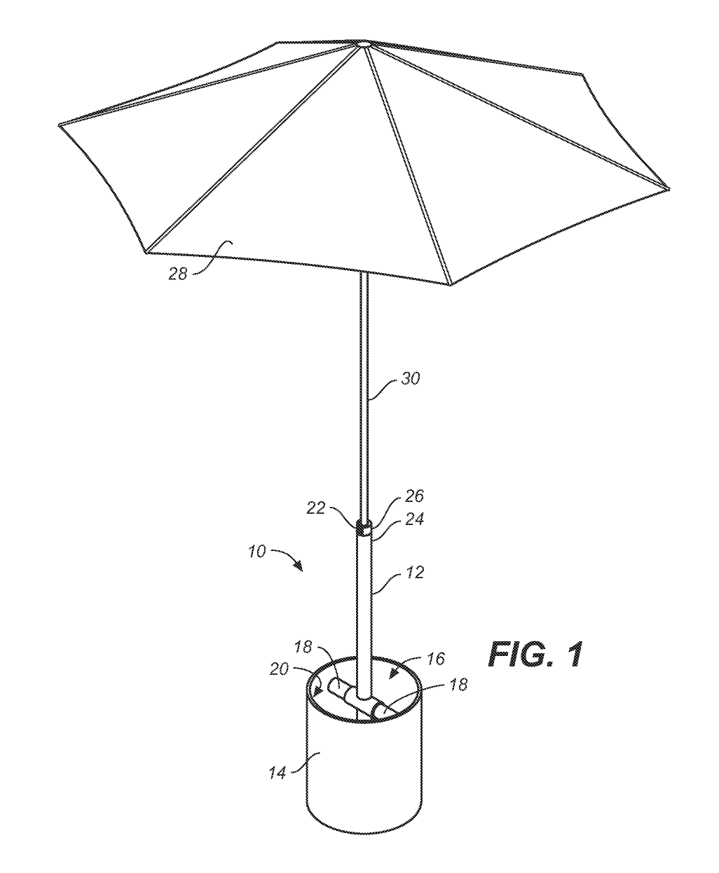

Referring to FIGS. 1 through 10, wherein like reference numerals refer to like components in the various views, there is illustrated therein a new and improved vertical support base and anchoring system, generally denominated 10 herein.

FIG. 1 illustrates a first preferred embodiment of the inventive vertical support base and anchoring system, showing its use as an umbrella support. In this embodiment, it will be seen that the system includes a vertical support tube 12 disposed in a ballast container 14 having an open top or upper end 16 and a closed bottom. The vertical support tube 12 includes laterally extending arms 18 that engage the interior side 20. The vertical support tube also includes a threaded neck 22 on its upper end 24 and a slotted locking collar 26 installed on the threaded neck to secure an umbrella 28 having a shaft 30 inserted into the upper end of the vertical support tube. The ballast container 14 is preferably either barrel-shaped (dolioform) or a bucket (for instance, a five-gallon bucket) with a closed bottom and a slight outward taper or slant to the bucket interior side or sides from bottom to top, such that the dimensions of the closed bottom (e.g., diameter and area, or lengths and widths and area) are slightly smaller than the corresponding dimensions of the open top. Alternatively, the bucket could be essentially any polygonal shape, as long as the interior side or sides taper uniformly outwardly from bottom to top and the inner dimensions of the bucket at its closed bottom are thus smaller than the dimensions at the open top. Thus, in a generally cylindrical (or dolioform) bucket, the single cylindrical side tapers outwardly from bottom to top and the bottom is thus slightly smaller in diameter and circumference than the top opening. Likewise, if the container were shaped in any of a number of suitable polygonal configurations, still having contiguous sides rather than a single continuous side, the dimensions of the bottom surface (area, diagonals, widths, lengths, etc., that is, any measurable dimension) would be smaller than the same dimension measured at the open top.

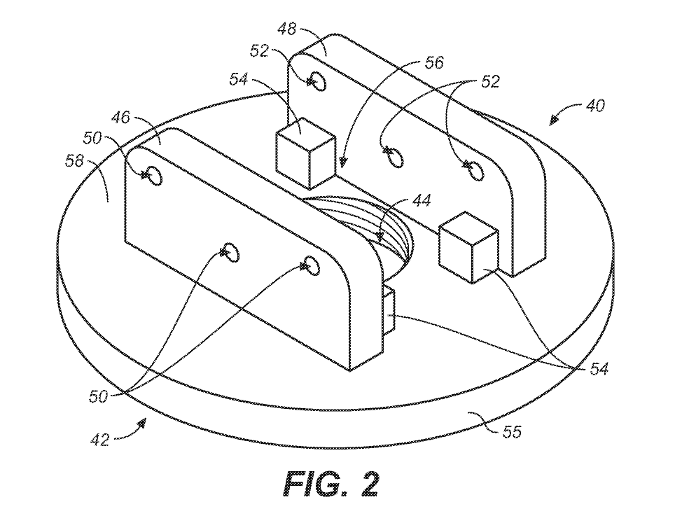

FIG. 2 shows a base plate 40 insertable into the ballast container for placement on the bottom of the container. The base has a generally planar bottom side 42, a threaded female socket 44 disposed on the upper side 58, vertically disposed parallel mounting brackets 46, 48, each having bolt holes 50, 52 for insertion of retaining bolts, and four corner elements 54 that cooperate with the mounting brackets 46, 48 to create a generally square socket 56 open at its ends for securing the bottom end of a 4×4 post disposed on the upper side 58 of the base plate. As with the ballast container, the base plate could take any of a number of suitable shapes conforming generally to the shape of the closed bottom, wherein the edge or edges 55 of the exterior perimeter is/are slightly smaller than the dimensions of the closed bottom so as to provide a slight clearance from the container sides to facilitate placement on the container bottom. Because of the slight outward taper, the base plate inserts easily into the ballast container and may be placed flat on the bottom for use. Further, the configuration of the parallel mounting brackets and corner elements could create an alternative open end socket, for instance for capturing and retaining a 2×4 length of lumber.

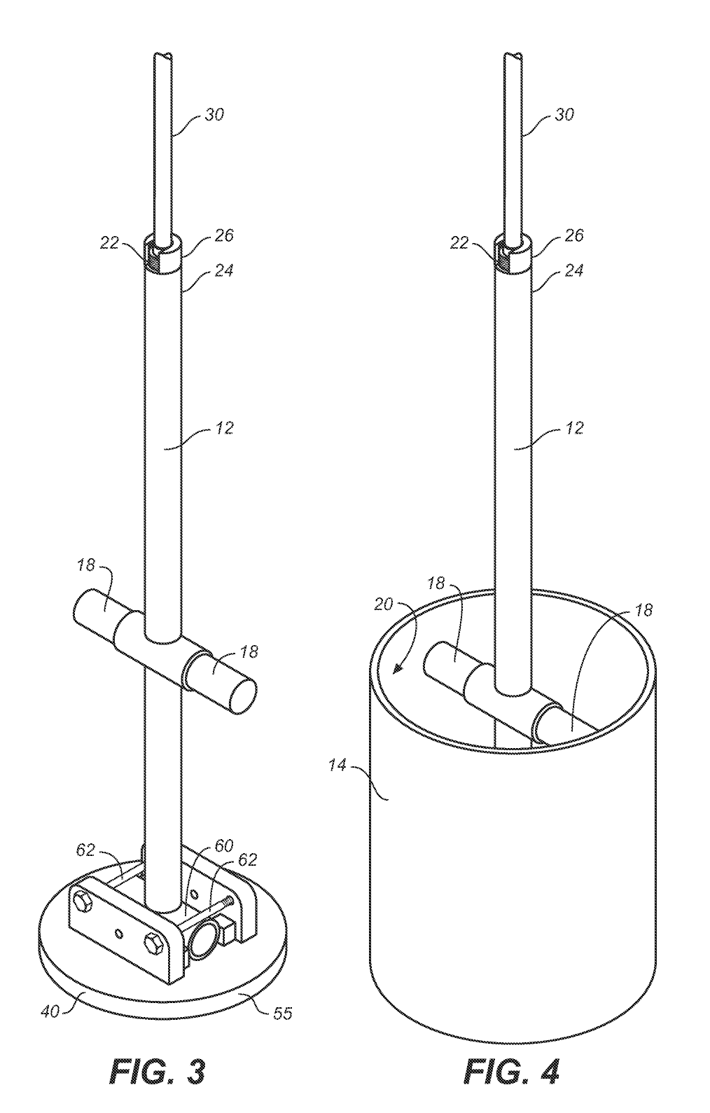

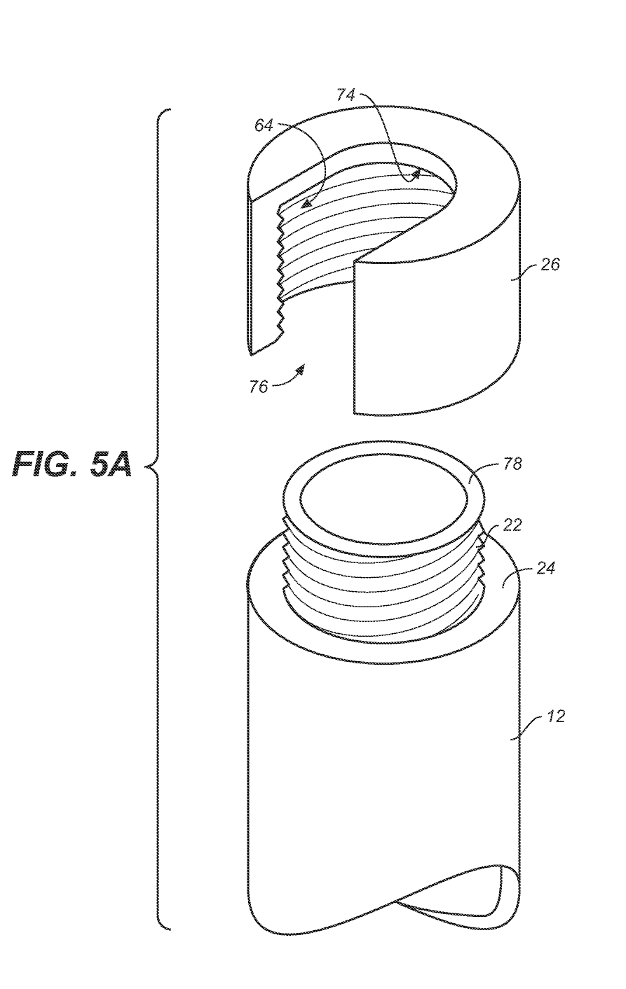

FIG. 3 shows a vertical support post 12 with a horizontally disposed lower end tube 60 secured between the opposing corner elements 54 on the interior sides of mounting brackets 46, 48. Bolts 62 are passed through bolt holes 50, 52 and over lower end tube 60 to secure the vertical support tube to the base plate. As shown in FIG. 4, this assembly is then capable of being installed in ballast container 14 with the base plate placed on the bottom of the container.

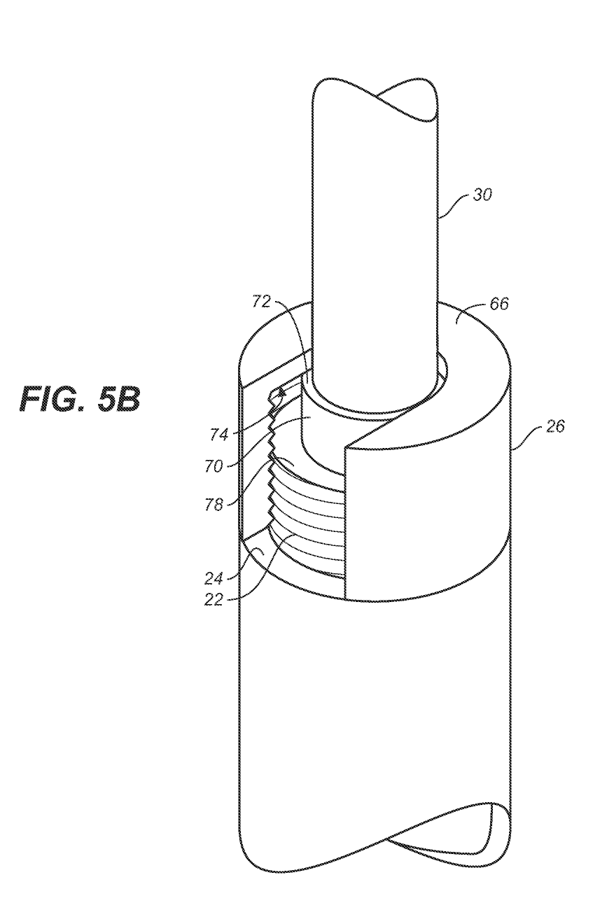

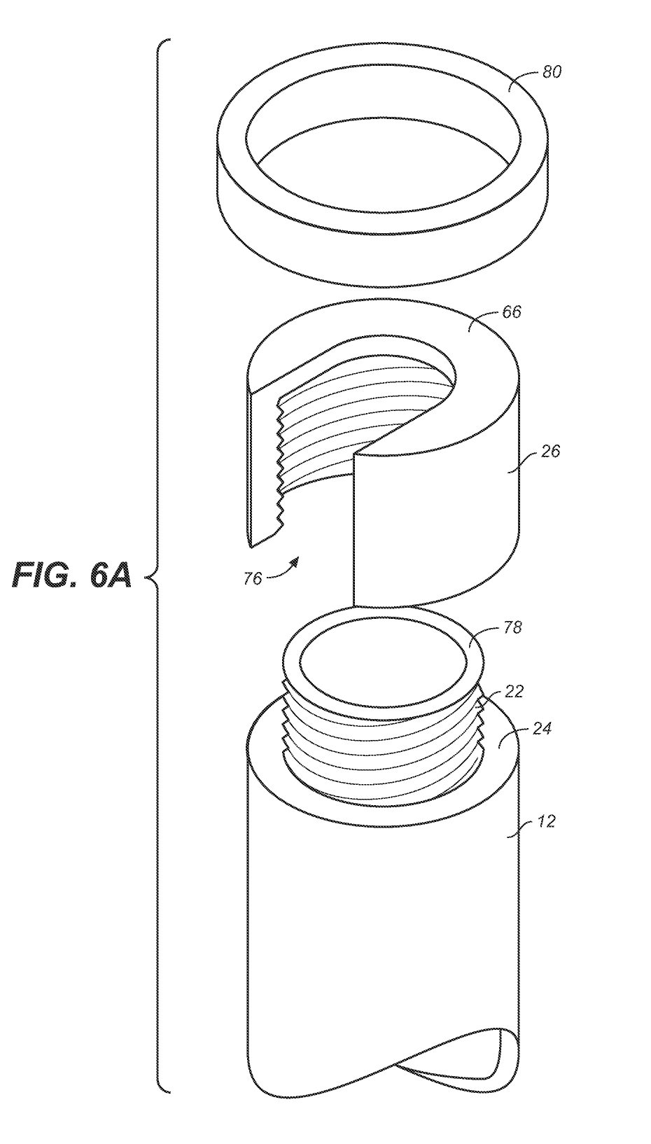

FIGS. 5A and 5B show details of the male threaded neck 24 at the upper end 24 of vertical support post 12. Slotted locking cap 26 includes complementary female threads 64 and sufficient top portion 66 such that when an umbrella shaft or rod 30 with a flange or ridge 70 is inserted into the vertical support tube, the upper edge 72 of the flange or ridge is captured by the underside 74 of the top portion 66 of locking cap 26. With the upper rim of the umbrella ridge on the rod) disposed at, on, or immediately below the upper rim of the threaded neck, the expanded feature (e.g., ridge or flange) is captured and retained in the vertical support tube by the locking cap, thereby capturing and retaining the entire shaft or rod. The slot 76 in the slotted locking cap is sized to accommodate a rod or an umbrella shaft having a diameter slightly smaller than the diameter of the umbrella handle or the flange or ridge. In the case of an umbrella handle, the diameter is, in turn, very slightly smaller than the inner diameter of the vertical support tube. Thus, the slot covers a radius of less than 180 degrees the circumference of the threaded interior, and preferably substantially less.

This locking cap assembly is also suitable to secure any kind of umbrella having a handle that can be disposed without the vertical support tube such that the upper edge of the handle is disposed below the upper rim 78 of the threaded neck 22; alternatively, it can secure any kind of rod having a flange, wherein the rod inserts into the vertical support tube and the ridge or flange overlaps the upper rim 78 of threaded neck 22. To use the assembly, the rod is simply inserted into the vertical support tube until the flange comes into contact or near contact with the upper rim 78. The locking cap is placed around the rod and then brought into threaded engagement with the threaded neck. It is then tightened until the flange is captured by the locking cap, thereby preventing removal of the rod from the vertical support 12. In this manner, once a flanged rod or an umbrella is installed into the vertical support and its flange disposed onto the upper rim of the vertical support, and once the flanged rod is secured onto the vertical support using the slotted locking cap of the above-described assembly, the rod will remain affixed to the vertical support until the slotted locking cap is loosened.

It will be appreciated that a vertical support member, such as a cylindrical rod with male threaded end could be threadably inserted directly into the female socket of the base plate, bypassing the need for the vertical support tube assembly. However, the tube assembly with its locking cap provides a quick set-up/take down option when rapid removal of an entire shade structure is desired or needed.

In a preferred use, the vertical support of the first preferred embodiment is first secured to the base plate and then the combination is installed in a bucket. Ballast is then placed in the bucket. This can comprise anything with significant mass, such as sand or rocks or other heavy material or objects. The rod or shaft or other elongate upright support or standard for an umbrella or other structure is inserted into the vertical support until either a handle or other edge is below the upper rim of the threaded neck or the rod flange is disposed on the upper rim. The slotted locking cap is then installed around the rod or shaft and dropped down into threaded engagement with the threaded neck. It is then screwed tight.

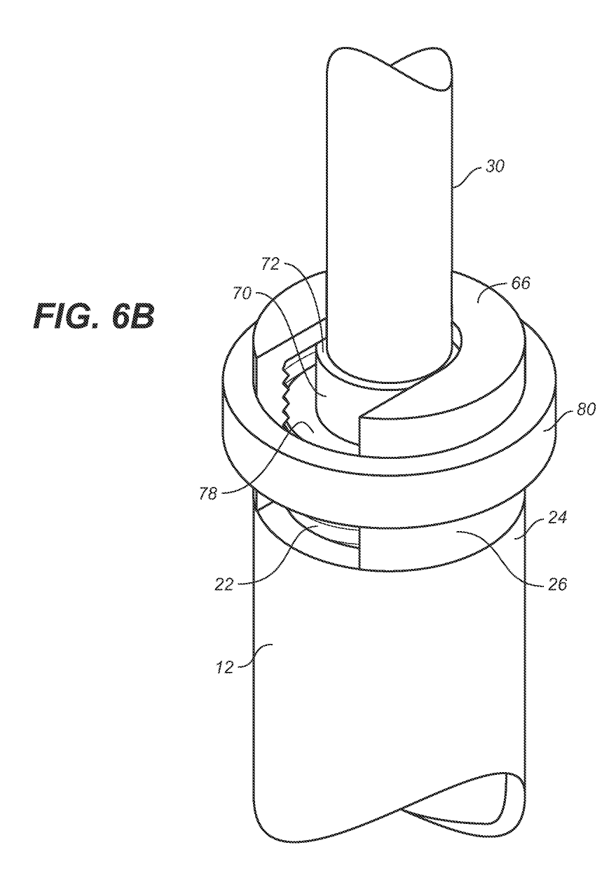

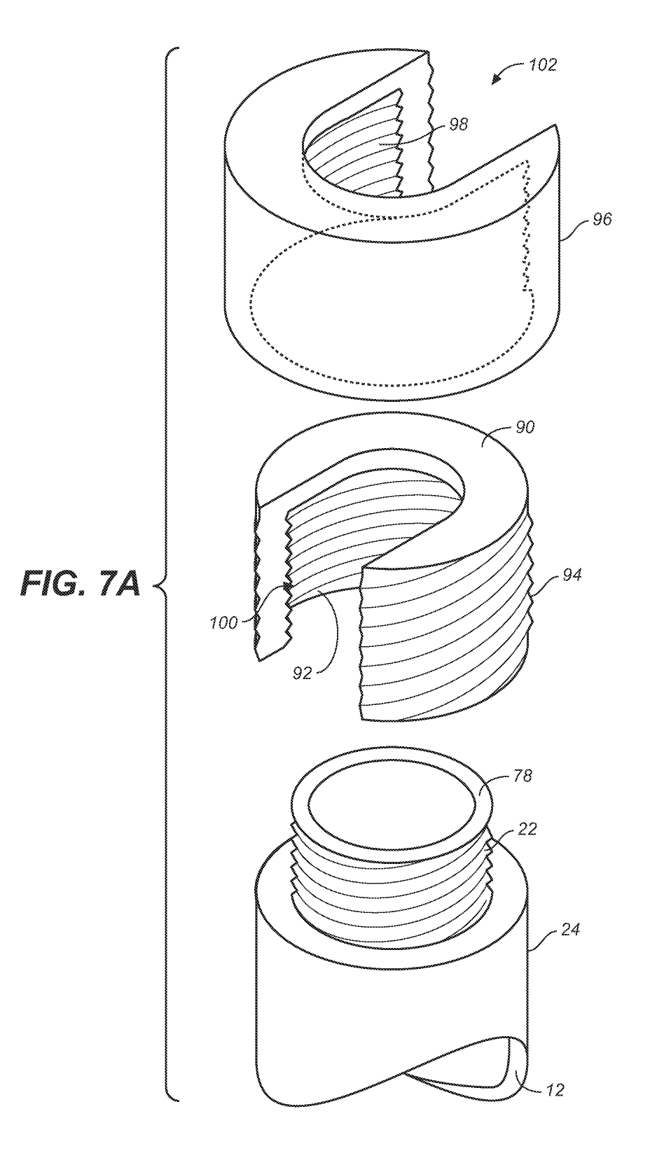

FIGS. 6A-6B show a second preferred embodiment of the slotted locking cap components of the inventive vertical support and anchoring system, wherein a locking ring 80 complements and completes an enclosure around the secured portion of an upright shaft 30, such as an umbrella shaft. In this instance the locking ring is not threaded but is simply pulled down over the slotted locking cap 26 and secured with a tight slip fit. When so secured the slotted locking cap and locking ring provide a full 360 degrees of circumferential support while yet allowing the shaft 30 and handle 70 to rotate freely about their axial axis within the hollow vertical support tube 12.

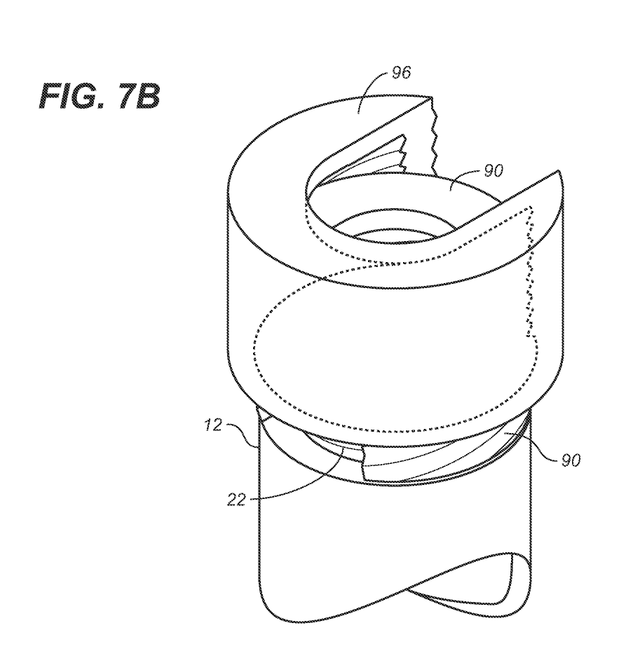

FIGS. 7A-7B show another embodiment of the slotted locking cap assembly, in this instance having a first (inner) slotted locking cap 90 with female threads 92 on its inner side and male threads 94 on its outer side. A second (outer) slotted locking cap 96 is sized to screw onto the first slotted locking cap and thus includes female threads 98 on its inner side. When the first slotted locking cap 90 is screwed down over a secured support pole or handle, as described above, it captures the handle or flange in or on the threaded neck 22. Then, when the second slotted locking cap is screwed onto the first slotted locking cap, the slots 100, 102, respectively, of the first and second slotted locking caps are offset and misaligned so as to provide full circumferential support for the shaft or pole or other upright member secured within the vertical support tube 12. Accordingly, in the case of an umbrella, side winds are permitted to spin the umbrella, thereby dissipating the force of the winds and preventing the winds from either ejecting the upright support from the vertical support tube and from tipping over.

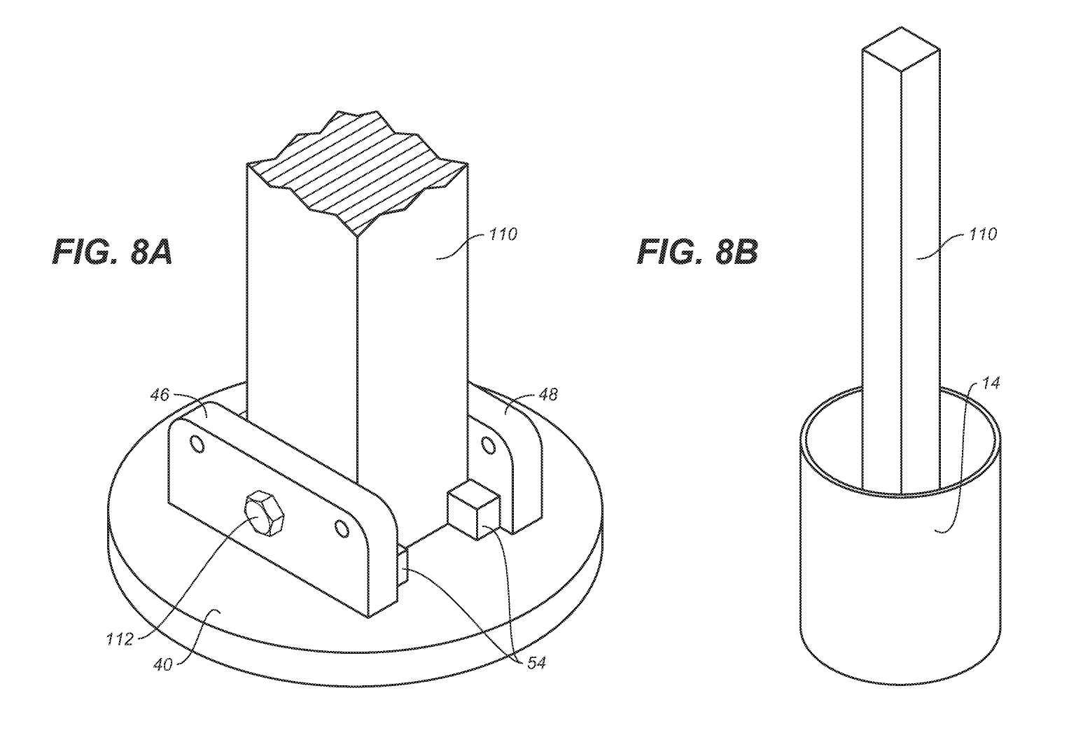

FIGS. 8A-8B show how a 4×4 wood post 110 can be secured between the parallel brackets 46, 48 and the corner elements 54 of a base plate 40 simply by passing a bolt 112 through the side of the parallel brackets and through the wood post. The assembled elements (post attached to plate) can then be placed into a ballast container 14 and anchored to the ground with heavy material placed within the container volume. Thus, a large temporary canopy or tent or other structure or shelter with heavy upright supports (such as the wood posts shown) can be erected and positioned on paved or rocky or other unyielding surfaces that do not permit (or only reluctantly permit) placement of stakes. Moreover, using this base and ballast anchoring method, the need for stakes and anchor lines is entirely obviated.

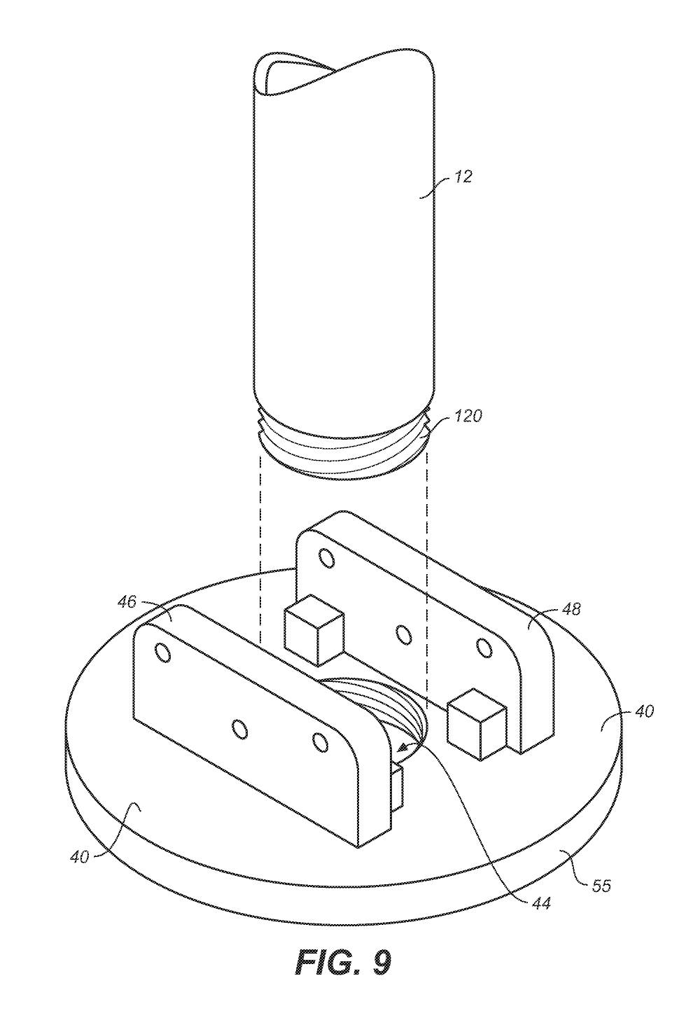

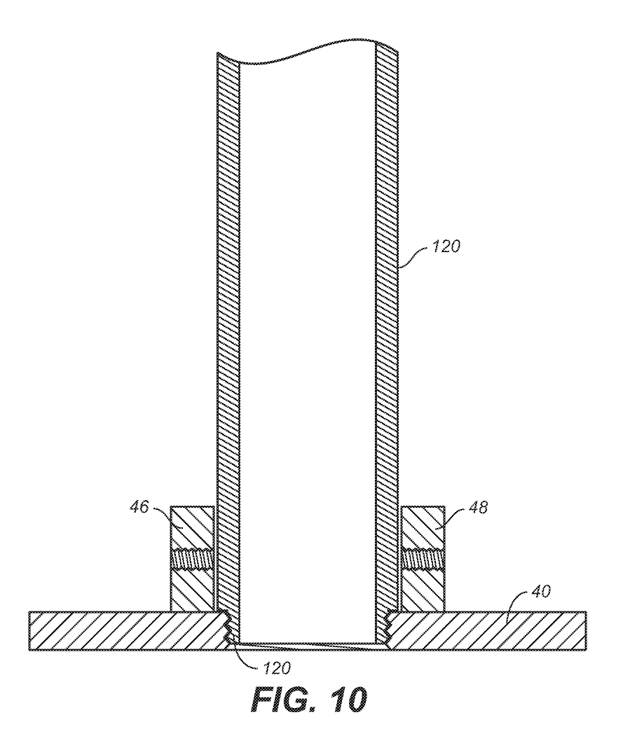

FIGS. 9-10 show how a vertical support tube 12 having a threaded end 120 can be secured in the female threaded receptacle 44 in the base plate 40. This accomplishes a secure connection in an alternative manner, again sufficient to prevent vertical translation of the connected vertical support tube and base plate out from the ballast container once it is weighted with ballast material.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A vertical support base and anchoring system, comprising:
a ballast container having an open top, a closed bottom, and an interior side or sides uniformly tapering slightly outward from said closed bottom to said open top such that the inner dimensions of said closed bottom are smaller than the inner dimensions of said open top; and
a base plate having a generally planar bottom side, an upper side, a threaded female socket disposed on said upper side, and vertically disposed parallel mounting brackets, each of said mounting brackets having holes for insertion of retaining bolts, and corner elements configured in relation to said mounting brackets to create a socket for securing the bottom end of a post disposed on said upper side of said base plate, said base plate generally conforming in shape to the shape of said closed bottom and having an outer perimeter edge slightly spaced apart from said interior sides, said base plate insertable into said ballast container for placement on said closed bottom.

2. The vertical support base and anchoring system of claim 1, further including:
a vertical support tube having laterally extending arms sized to engage said interior sides of said ballast container, and further having a threaded neck on its upper end; and
a slotted locking cap threadably installable on said threaded neck and an upper rim for securing a rod or umbrella having a shaft inserted into the upper end of the vertical support tube and a ridge element disposed either below or on said upper rim.

3. The vertical support base and anchoring system of claim 2, wherein said slotted locking cap includes a side slot open so as to allow placement of said locking cap around an elongate shaft, said side slot extending less than 180 degrees of the circumference of the threaded interior of said slotted locking cap.

4. The vertical support base and anchoring system of claim 3, further including a locking ring to provide 360 degrees of circumferential support and enclosure around a secured portion of an upright shaft while yet the secured shaft to rotate freely about its longitudinal axis within the said vertical support tube.

5. The vertical support base and anchoring system of claim 1, wherein said locking cap is a first slotted locking cap that includes a threaded outer side, and further including a second slotted locking cap having a threaded cylindrical interior sized to screw onto said first slotted locking cap.

6. The vertical support base and anchoring system of claim 5, wherein said first slotted locking cap screws down onto and secures support pole or handle on said threaded neck, and wherein said second slotted locking cap screws onto said first slotted locking cap such that the slots in each of said locking caps may be offset and misaligned so as to provide full circumferential support for a shaft, pole, or other upright member secured within said vertical support tube.

7. The vertical support base and anchoring system of claim 6, wherein a shaft, pole, or other upright member secured within said vertical support tube has both full circumferential support and freedom to spin within said vertical support tube.

8. The vertical support base and anchoring system of claim 1, wherein said mounting brackets include a plurality of holes for bolting an upright support in place.

9. The vertical support and anchoring system of claim 1, wherein said base plate further includes a female threaded socket disposed below the upper surface of said base plate, said female threaded socket configured to accept a threaded male end on a support rod.

10. The vertical support and anchoring system of claim 9, further including a ballast container within which to place said base plate and ballast material on top of said base plate.

11. A method of supporting and anchoring a vertical support member, comprising:
providing a ballast container having an open top, a closed bottom, and an interior side or sides uniformly tapering slightly outward from the closed bottom to the open top such that the inner dimensions of the closed bottom are smaller than the inner dimensions of the open top;
providing a base plate having a generally planar bottom side, an upper side, a threaded female socket disposed on the upper side, and vertically disposed parallel mounting brackets, each of said mounting brackets having holes for insertion of retaining bolts, and corner elements configured in relation to the mounting brackets to create a socket for securing the bottom end of a post disposed on the upper side of the base plate, the base plate generally conforming in shape to the shape of the closed bottom and having an outer perimeter edge slightly spaced apart from the interior sides, the base plate being insertable into the ballast container for placement on the closed bottom;
providing a vertical support member;
securing the vertical support member to the base plate; and
placing the combined vertical support member and base plate into the ballast container such that the bottom side of the base plate rests on the closed bottom of the ballast container; and

12. The method of claim 11, wherein the vertical support member is a length of lumber with at least one bolt hole at its lower end, and wherein the step of securing the vertical support member to the base plate involves bolting the vertical support member to the base plate.

13. The method of claim 11, wherein the base plate includes a female threaded socket.

14. The method of claim 13, further including:
providing the vertical support member in the form of a vertical support tube having a male threaded lower end for threadable insertion into the female socket of the base plate and a threaded neck on its upper end; and
providing a slotted locking cap for threadable attachment to the threaded neck so as to capture and secure a vertical support member.

15. The method of claim 14, wherein the vertical support member is a rod having a threaded lower end threadably insertable into the female socket.

16. The method of claim 14, wherein the vertical support member is an elongate rod having a lower end sized to insert into the vertical support member and a flange or ridge or handle captured by the slotted locking cap when the slotted locking cap is installed.

17. The method of claim 16, wherein the slotted locking cap is a first slotted locking cap and includes a threaded exterior surface, and further including providing a second locking cap having female threads for threadable connection to the first slotted locking cap.

18. The method of claim 17, further including the step of placing ballast material in the ballast container over the base plate.

19. The method of claim 11, further including the step of placing ballast material in the ballast container over the base plate.
